(19) United States
(12) Patent Application Publication
(10) Pub. No.: US 2002/0063672 A1
(43) Pub. Date: May 30, 2002

(54) Method of gray scale generation for displays using a sample and hold circuit with discharge

(76) Inventor: Jessica L. Stevens, San Mateo, CA (US)

Correspondence Address: Lisa M. Yamonaco, Telegen Corporation, Suite 200, 1840 Gateway Drive, San Mateo, CA, 94404, US

(21) Appl. No.: 09/726,074

(22) Filed: Nov. 29, 2000

(51) Int. Cl. G09G 3/36

(52) U.S. Cl. 345/89; 345/690

(57) ABSTRACT

A circuit and method for generating pulse width modulated signal from an analog video signal. The circuit includes a first circuit portion that includes a first switch, a voltage storage device that stores a portion of the analog video signal as a voltage value according to the first switch activated according to sample time information within a portion of time of the analog video signal, and a second switch that outputs the stored voltage value when activated according to a next portion of time of the analog video signal. The circuit also includes a second circuit portion that converts the outputted voltage value into a pulse width modulated signal.

The present invention is related to the following co-pending U.S. patent applications: ______ entitled “Method of Gray Scale Generation For Displays Using a Binary Weighted Clock;” ______ entitled “Method of Gray Scale Generation For Displays Using a Register and a Binary Weighted Clock;” and ______ entitled “Method of Gray Scale Generation For Displays Using a Sample and Hold Circuit With a Variable Reference Voltage.”

### FIELD OF THE INVENTION

The present invention relates to displays and more particularly to driving display pixels according to a gray scale value.

### BACKGROUND OF THE INVENTION

Most displays must support many levels of brightness, i.e. shades of gray or “gray scale”, for each pixel element. With the exception of the cathode ray tube, the cost of gray scale driver electronics is one of the largest component costs of a display system. This is because of the complexity of generating gray scale as well as the fact that there are far more gray scale drivers needed in a display than any other driver element.

For example, in an SVGA Field Emission Display, there are 800 columns, each column composed of 3 sub-columns (Red, Green and Blue) and 600 rows or lines. Each row requires a simple ON or OFF driver, essentially a twolevel driver, and there are 600 drivers required per display. Each sub-column, however, requires a gray scale driver that may be required to provide 256 or more different levels of brightness, and there are one gray scale driver required per each sub-pixel or 800×3=2,400 of these drivers required per display. Thus, if the row and column drivers cost exactly the same, there would still be a 4:1 ratio of costs due simply to the number of drivers. However gray scale drivers are actually much more expensive than simple two-level drivers since they contain significantly more circuitry and therefore the additional cost would be much greater than 4:1.

There are two methods of generating the differing levels of pixel brightness in a gray scale driver. The first method is to vary the output voltage or output current provided by the driver. The higher the voltage or current, the brighter the pixel brightness. However, when the brightness is less than maximum, the excess energy that does not go to lighting the pixel is dissipated across the driver, generating heat. This makes the driver expensive because it must dissipate this heat in order to properly operate and few drivers can be packed in one chip because of this heat problem. It is also very complicated and expensive to build a driver which translates digital picture information into the varying output voltages or currents needed for gray scale. Additionally, when the pixel is driven at a low brightness level with reduced voltage or current, the pixel may not be driven at its full efficiency, causing reduced display efficiency and uneven pixel illumination and sharpness.

The second method overcomes these heat and efficiency problems by utilizing the fact that the human eye cannot perceive fast changes in brightness and therefore integrates, or averages, the total light received over time and “sees” an average brightness. In this method, known as Pulse-Width Modulation, the pixel is driven at maximum brightness for a certain period of time and then turned off for another period of time. Because the driver circuit is only fully on or fully off, a minimum amount of the energy is lost in the driver and the pixel is always on at full efficiency. By varying the portion of a cycle that the pixel is lit, the perceived brightness can be varied from barely on to fully on.

However, the circuits to accomplish this second method of gray scale are very complicated. As can be seen in FIG. 1A, a typical gray scale circuit includes a latch or shift register to store the binary gray scale number before it is used, a latch to store the active gray scale number, a counter to generate the time slots, a comparator circuit to determine if the counted number is less than, equal to or greater than the stored gray scale number, and a driver transistor.

In the operation of the circuit shown in FIG. 1A, the binary gray scale number is first stored in the latch or shift register for later transfer to the active latch. After the data is transferred to the active latch, the counter is reset to zero and then begins counting up to a maximum number, which defines one complete brightness cycle, defined as T in FIG. 1B. Each time the counter counts up, its output is compared by the comparator circuit with the gray scale number stored in the active latch. If the stored number in the active latch is lower than the count number from the counter, the comparator circuit will set the driver transistor to ON. When the gray scale number becomes equal to or greater than the count from the counter, the comparator circuit turns the driver transistor to OFF. The period of time when the driver is ON is shown as X in FIG. 1B. The overall brightness of the pixel in the typical gray scale circuit described in FIG. 1A is defined by the ratio of X to T shown in FIG. 1B, where X is defined as the time the driver is ON and T is defined as the total time period for one complete brightness cycle. This solution requires a large amount of circuitry to drive a pixel according to gray scale.

Therefore, there exists a need to reduce the amount of gray scale circuitry to drive a pixel for various types of flat panel displays.

### SUMMARY OF THE INVENTION

The present invention provides a circuit for generating pulse width modulated signal from an analog video signal. The circuit includes a first circuit portion that includes a first switch, a voltage storage device for storing a portion of the analog video signal as a voltage value according to the first switch activated according to sample time information within a portion of time of the analog video signal, and a second switch for outputting the stored voltage value when activated according to a next portion of time of the analog video signal. The circuit also includes a second circuit portion for converting the outputted voltage value into a pulse width modulated signal.

In accordance with further aspects of the invention, the second circuit portion is a Schmidt trigger with a preset bias voltage value.

In accordance with other aspects of the invention, the second circuit portion is a comparator.

In accordance with still further aspects of the invention, the stored portion of the analog video signal represents display element information.

In an alternate embodiment, the present invention provides a circuit that includes for generating pulse width modulated signal from an analog video signal that includes a first and second circuit portion. The first circuit portion includes a first and second subcircuit portion. The first subcircuit portion includes a first switch, a voltage storage device that stores a portion of the analog video signal as a voltage value within a period of time according to the first switch activated according to sample time information within the period of time, and a second switch that outputs the stored voltage value when activated during a subsequent period of time. The second subcircuit portion includes a first switch, a voltage storage device that stores a next portion of the analog video signal as a voltage value within the subsequent period of time according to the first switch activated according to sample time information within the subsequent period of time, and a second switch that outputs a previously stored voltage value when activated during the period of time. The second circuit portion converts the outputted voltage values from the first and second circuit portions into pulse width modulated signals. This alternate embodiment allows the gray scale information for a display element to be outputted while the gray scale information for a display element is a next row is stored.

As will be readily appreciated from the foregoing summary, the invention provides an improved circuit for generating a pulse width modulated signal for sending gray scale information to a display.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIGS. 1A and B are diagrams illustrating the prior art;

FIGS. 2A-C illustrates a first embodiment of the present invention;

FIG. 3 is a circuit diagram of a video display system formed in accordance with the present invention;

FIG. 4 is a block circuit diagram of the present invention;

FIGS. 5 and 6 are detailed circuit diagrams of the block circuit diagram shown in FIG. 4;

FIGS. 7 and 8 are timing diagrams of an example of the present invention.

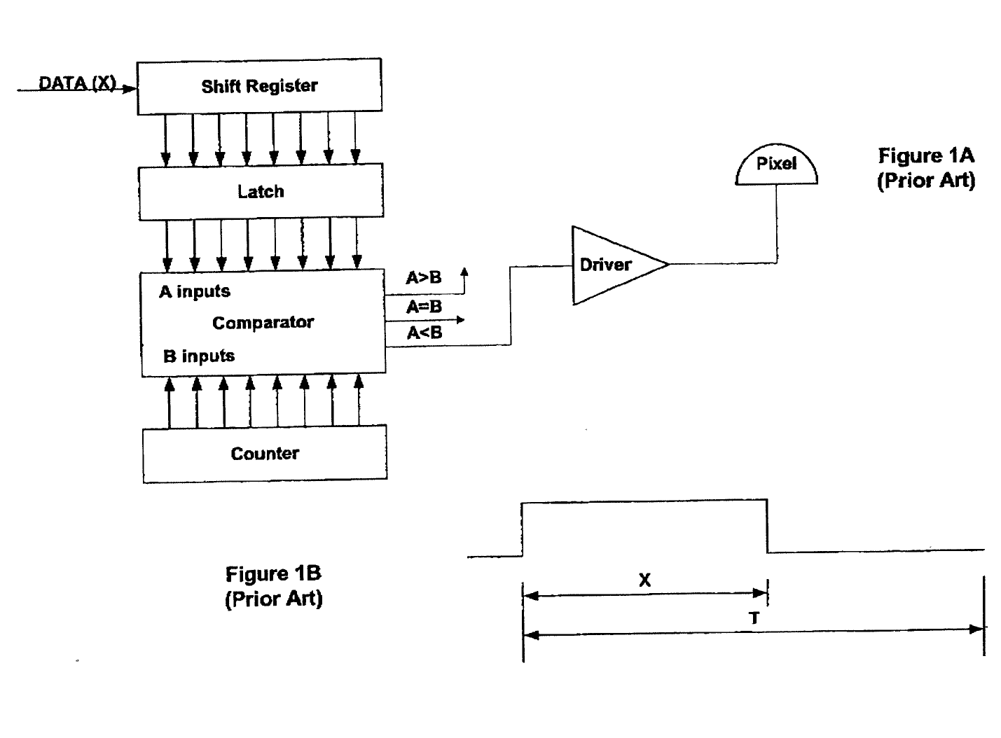

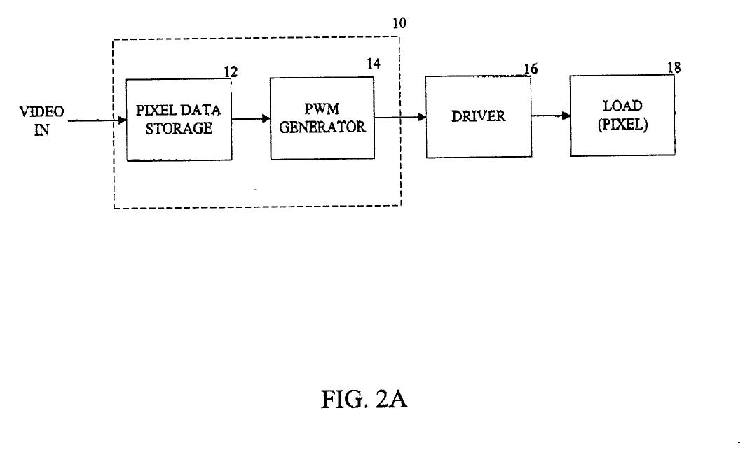

### DETAILED DESCRIPTION OF THE PREFERRED EMBODIMENT

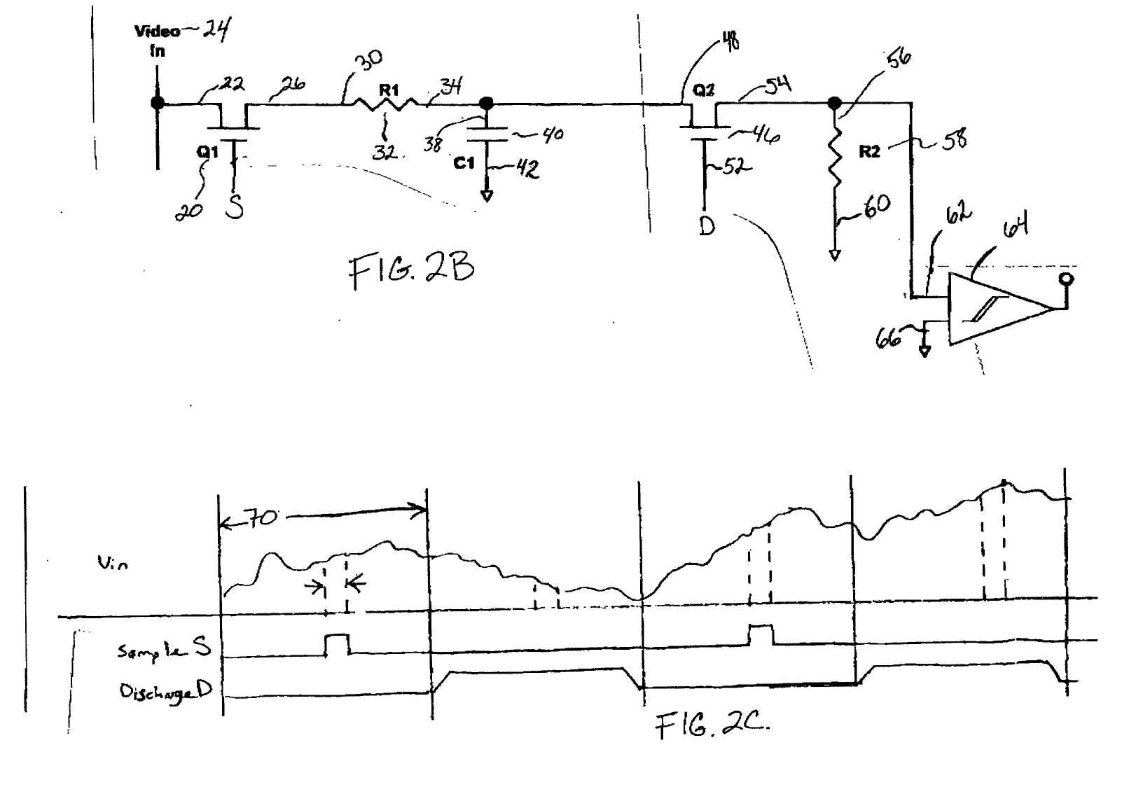

The present invention is an analog to pulse width modulated signal generator (APWM). One use of the APWM is to drive the gray scale exhibited by phosphor pixels in a display. In an first embodiment, the present invention provides a separate set of circuitry for each pixel element or sub-pixel, thereby providing separate driving circuitry for each pixel element or sub-pixel (i.e. an active matrix display). As shown in FIG. 2A, each pixel element or sub-pixel includes its own circuitry 10 that includes a pixel data storage circuit 12 and a pulse width modulation (PWM) generator circuit 14. The pixel data storage circuit 12 samples and stores a data portion of the analog video signal. The PWM generator circuit 14, at a preset time, discharges the stored data portion to a driver 16 that then drives a pixel or subpixel 18.

An example circuit suitable for implementing the first embodiment is illustrated in FIG. 2B. The pixel data storage circuit 12 includes a transistor Q1 20 with its source 22 coupled to a video bus 24 and its drain 26 connected to a first end 30 of a resistor R1 32. A gate 44 of the transistor Q1 20 is connected to a sampling signal S. A second end 34 of the resistor R1 32 is coupled to a first side 38 of a capacitor 40. A second side 42 of the capacitor 40 is tied to ground.

The PWM signal generator circuit 14 includes a transistor Q2 46 that has its source 48 connected to the first side 38 of the capacitor 40. A gate 52 of the transistor Q2 46 is connected to a discharge signal D. A drain 54 of the transistor Q2 46 is coupled to a first end 56 of a resistor R2 58. A second end 60 of the resistor R2 58 is tied to ground. The first end 56 of the resistor R2 58 is also connected to a first input 62 of a Schmidt trigger (or a comparator) 64. The second input 66 of the Schmidt trigger is tied to ground or an appropriate reference voltage.

In an alternate embodiment, the resistors R1 32 and R2 58 are replace with constant current sources.

An example timing diagram of the sampling signal S and the discharge signal D are shown in FIG. 2C. Time width 70 corresponds to the horizontal sync pulses of the analog video signal. Because the circuitry of this first embodiment produces a digital PWM signal for a single pixel, the transistor Q1 20 allows the capacitor 40 to charge to a voltage value that is an approximate average of a sample period, as determined by the sampling signal S, of the analog video signal that corresponds to the pixel. The transistor Q2 46 allows the capacitor 40 to discharge the stored, sampled voltage value, as determined by the discharge signal D, to the driver 16.

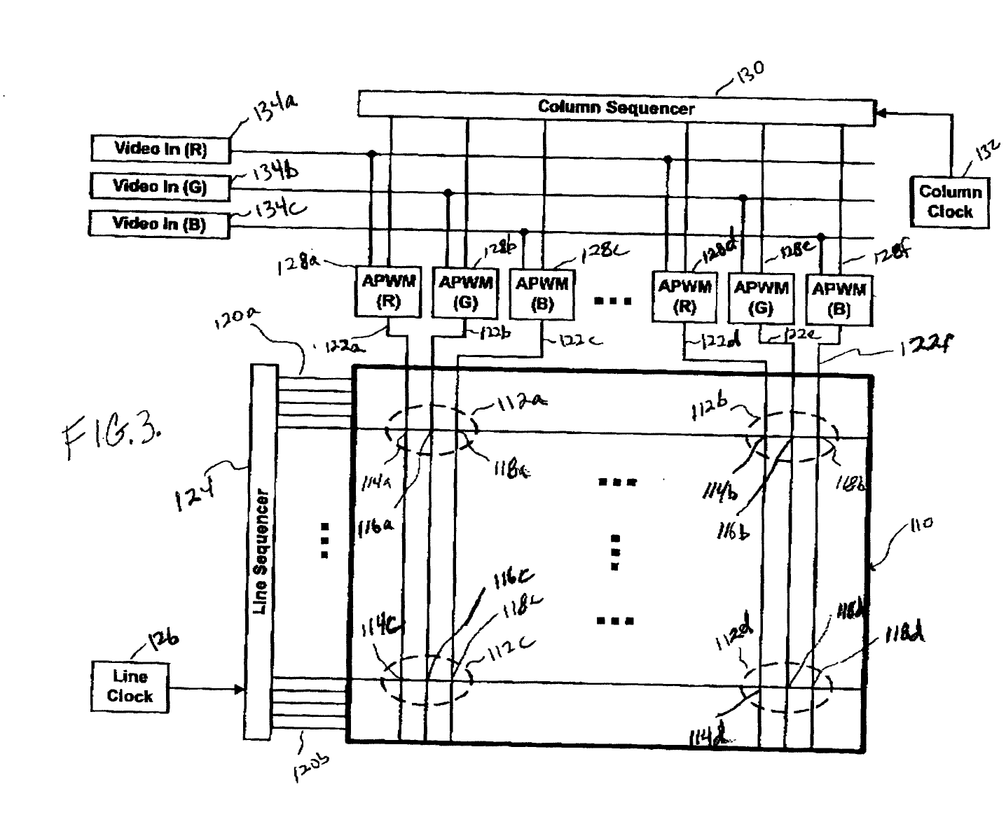

In a second embodiment, as shown in FIG. 3, a display 110 has a plurality of pixels 112a-d. The display may be monochrome or color. When the display is color each pixel 112a-d comprises three sub pixels: red (R) 114a-d, green (G) 116a-d and blue (B) 118a-d. To simplify the discussion, the following discussion will mostly refer to the pixels 112a-d as if they are monochrome, with the understanding that invention can also be applied in the manner described to sub-pixels 114a-d, 116a-d, 118a-d in a color display.

As is well known in the art, each pixel 112a-d may be electrically coupled to display drivers through scan line or active matrix addressing. The scan line configuration is illustrated in FIG. 3 and used in the following description. The present invention may also be coupled to the pixels 112a-d in active matrix fashion, as will be apparent to one skilled in the art. In a scan line configuration, each pixel 112a-d is addressed by the correspondence of a line 120a-b and a column 122a-f. A pixel 114a is activated when a line 120a (acting as a cathode) and a column 122a (acting as an anode) provide an electrical path for current to excite a phosphor pixel to throw off photons. An example display 110 has 480 lines that are sequentially activated so that each line is accessed once in a period of approximately 1/30^{th} of a second. This “paints” the screen in a short enough period that the human eye does not perceive the scan of the individual lines. The activation of each line 120a-b is controlled by a line sequencer 124 that addresses each line according to timing provided by a line clock 126.

As each line 120a-b is activated, the corresponding column 122a-b is activated with a pulse width modulated signal that supplies power to the pixel 112a-d. A pulse width modulated signal is a signal that provides power through one or more pulses that occur during a signal period, which in this use corresponds approximately to the time that the column is activated to control the pixel. The power supplied by the pulse width modulated signal is described as a proportion of total available power, or duty cycle. The pulse width modulated signal is provided by an analog to pulse width modulated signal generator (APWM) 128a-f. An APWM 128a-f is coupled to each column 122a-f. In an active matrix configuration, an APWM 128a-f is coupled to each pixel 112a or sub-pixel 114a-d, 116a-d or 118a-d. Each APWM 128a-f is coupled to a column sequencer 128 that controls the activation of the APWM 128a-f to correspond with the column timing. The column timing is provided by a column clock 132, that is coupled to the column sequencer 130. Generally, the column clock 132 is derived from the line clock 126. For instance, an example display will have 640 columns for each line, or 640 column timing pulses occurring during each of the 480 line pulses generated by the line clock 126.

Each APWM 128a-f is coupled to a data bus 134a-c that supplies an analog video signal, such as NTSC or PAL, to the APWN 128a-f. The analog signal has a voltage that varies over time within known parameters. By sampling the voltage at a given time in the analog signal, a gray scale value for a particular pixel 112a-d can be determined. In an embodiment of the invention, a composite video signal is divided into an analog gray scale signal for each of the primary colors RGB and placed onto a video in signal bus R 134a, G 134b and B 134c. Each APWM's is coupled to the data bus that corresponds with the color of their sub-pixel, i.e., APWM 128a & d to R data bus 134a, APWM 128b & e to G data bus 134b, and APWM 128d & f to B data bus 134c. Only a single data bus is necessary for a monochrome display.

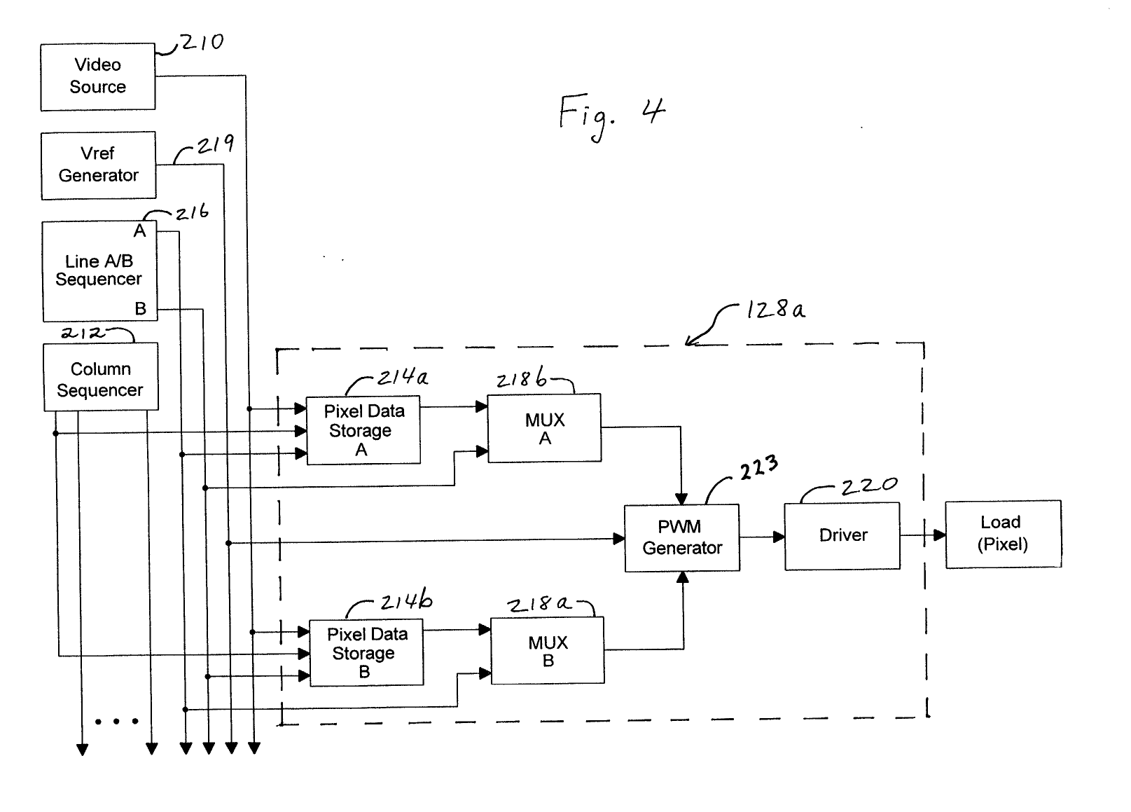

In FIG. 4, the present invention is illustrated in block format. A video source block 210 supplies an analog video signal. A column sequencer 212 determines the appropriate time during a video line to activate an AWPM 128a to sample the analog video signal. The AWPM 128a comprises a pixel data storage “A” circuit 214a and a pixel data storage “B” circuit 214b that are alternately coupled to the analog video signal by a line A/B sequencer circuit 216. The A/B sequencer circuit 216 also alternately activates a multiplexer (mux) “B” circuit 218a and a mux “A” circuit 218b. The A/B sequencer determines the time that a current line is active and changes states at a next line. During a current line, the A/B sequencer enters an “A” state during which the pixel data storage A circuit 214a and the mux B 218b circuit are active. When a next line becomes the current line, the A/B sequencer circuit 216 enters a “B” state during which the pixel data storage B circuit 214b and the mux A circuit 214b are active. A next line alternates the A/B sequencer circuit 216 back to the “A” state, and so on.

The mux B circuit 218a at the appropriate time connects to PWM Generator 223 to generate a pixel data value or voltage value stored by the pixel data storage B circuit 214b to PWM generator 223 comparison to a voltage reference signal V_{ref} 219 that is supplied to the PWM Generator 223 circuit which at the appropriate time outputs the PWM signal to a driver circuit 220. Similarly, the mux A circuit 218b connects a pixel data value stored by the pixel data storage A circuit 214a to PWM generator 223 for comparison to the voltage reference signal V_{ref} 219 that is supplied to the PWM Generator circuit 223 which outputs the PWM signal to the driver circuit 220. When the A/B sequencer circuit 216 is in the A state, the pixel data storage A circuit 214a samples and holds the pixel data (voltage) value from the input video signal 210 and the PWM generator circuit 223 generates a PWM signal based on the pixel data value stored in the pixel data storage B circuit 214b—stored during a previous “B” state, and now connected to the PWM generator 223 via mux B circuit 218a. At the next line, the A/B sequencer circuit 216 transitions to the B state where the pixel data storage B circuit 214b samples and holds the pixel data value from video signal 210 and the PWM generator circuit 223 generates a PWM signal based on the pixel data value stored in the pixel data storage A circuit 214a—stored during a previous “A” state, and now connected to the PWM generation circuit 223 via mux A circuit 218b. A pixel 222 (or other load) is driven by the driver circuit 220 when the column sequencer 212 activates the APWM 128a with either the mux B circuit 218a or the mux A circuit 218b, which alternately provide the PWM generator circuit 223 with a stored pixel data values or voltages for generation of PWM signals which form the inputs to the driver circuit 220.

In an alternate embodiment for an active matrix display, a pixel element or sub-pixel includes its own circuitry, i.e. one pixel data storage circuit and one PWM generator circuit. The only other component needed for this alternate embodiment is a column sequencer coupled to the pixel data storage circuit.

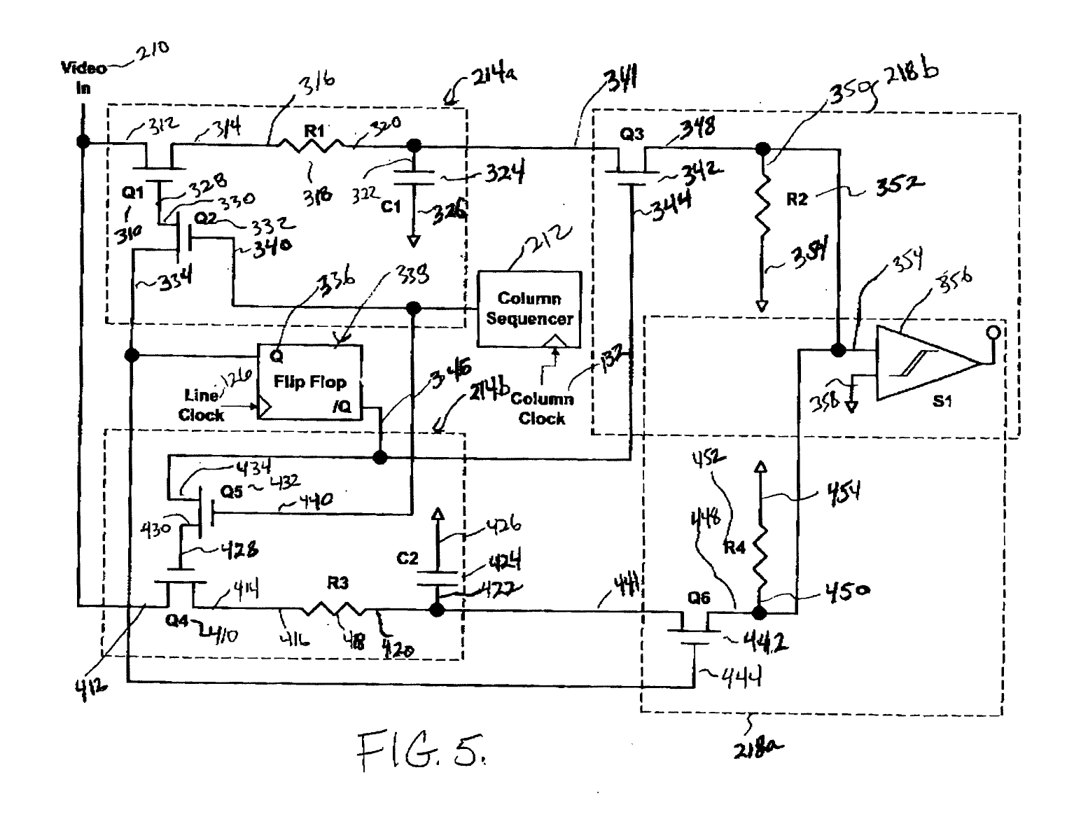

An example circuit suitable for implementing the present invention is illustrated in FIG. 5. The pixel data storage A circuit 214a includes a transistor Q1 310 with its source 312 coupled to a video bus 210 and its drain 314 connected to a first end 316 of a resistor R1 318. A second end 320 of the resistor R1 318 is coupled to a first side 322 of a capacitor 324. A second side 326 of the capacitor 324 is tied to ground. A gate 328 of the transistor Q1 310 is connected to a drain 330 of a transistor Q2 332. A source 334 of the transistor 332 is coupled to a non-inverting output Q of a Flip Flop 338 (Sequencer 216). A gate 340 of the transistor Q2 332 is connected to the column sequencer 212. The column sequencer 212 is connected to a column clock 132 (FIG. 3) and the Flip Flop 338 is connected to the line clock 126 (FIG. 3).

The PWM signal generator A circuit 218b includes a transistor Q3 342 that has its source 341 connected to the first side 322 of the capacitor 324. A gate 344 of the transistor Q3 342 is connected to an inverting output 346 of the Flip Flop 338. A drain 348 of the transistor Q3 342 is coupled to a first end 350 of a resistor R2 352. A second end 354 of the resistor R2 is tied to ground. The first end 350 of the resistor R2 352 is also connected to a first input 354 of a Schmidt trigger S1 (or a comparator) 356. The second input 358 of the Schmidt trigger S1 is tied to ground or an appropriate reference voltage. In the case where a comparator 356 is used, the second input 358 to comparator 356 would be a connected to a Vref Generator 219 (as shown in FIG. 4), which would supply a reference voltage.

The pixel data storage B circuit 214b includes a transistor Q4 410 with its source 412 coupled to the video bus 210 and its drain 414 connected to a first end 416 of a resistor R3 418. A second end 420 of the resistor R3 418 is coupled to a first side 422 of a capacitor 424. A second side 426 of the capacitor 424 is tied to ground. A gate 428 of the transistor Q4 410 is connected to a drain 430 of a transistor Q5 432. A source 434 of the transistor Q5 432 is coupled to the inverting output/Q 346 of the Flip Flop 338. A gate 440 of the transistor Q5 432 is connected to the column sequencer 212.

The PWM signal generator B circuit 218a includes a transistor Q6 442 that has its source 441 connected to the first side 422 of the capacitor 424. A gate 444 of the transistor Q6 442 is connected to a non-inverting output Q 346 of the Flip Flop 338. A drain 448 of the transistor Q6 442 is coupled to a first end 450 of a resistor R2 452. A second end 454 of the resistor R2 is tied to ground. The first end 450 of the resistor R2 452 is also connected to the first input 354 of a Schmidt trigger S1 (or a comparator) 356.

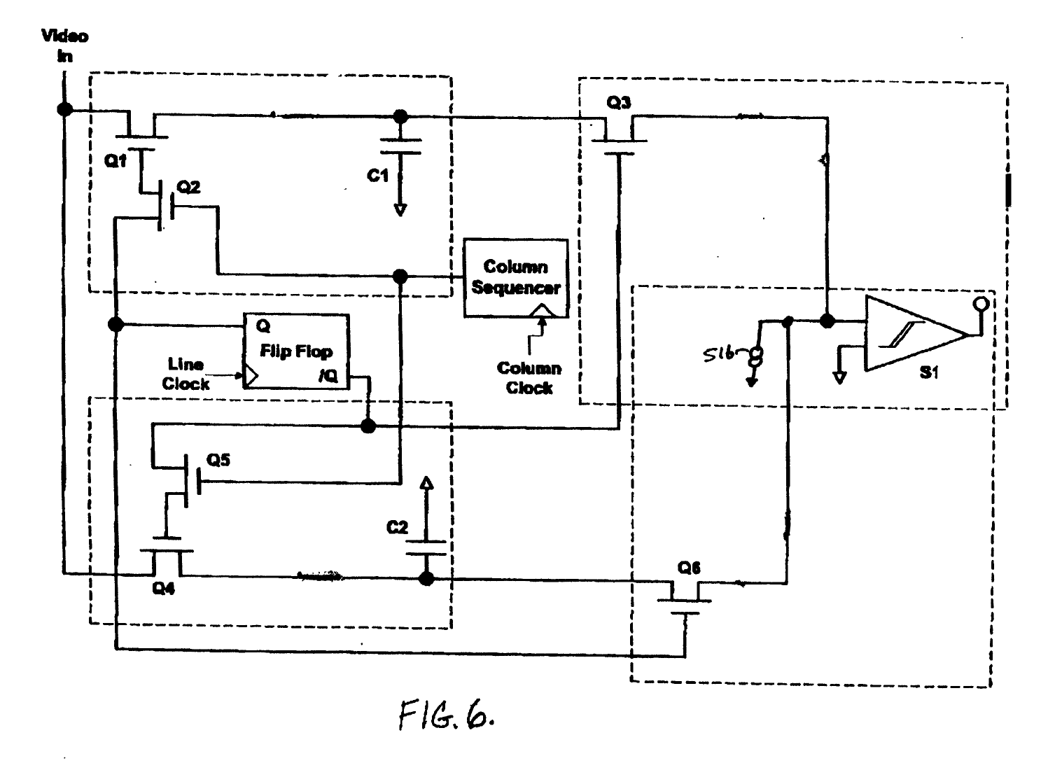

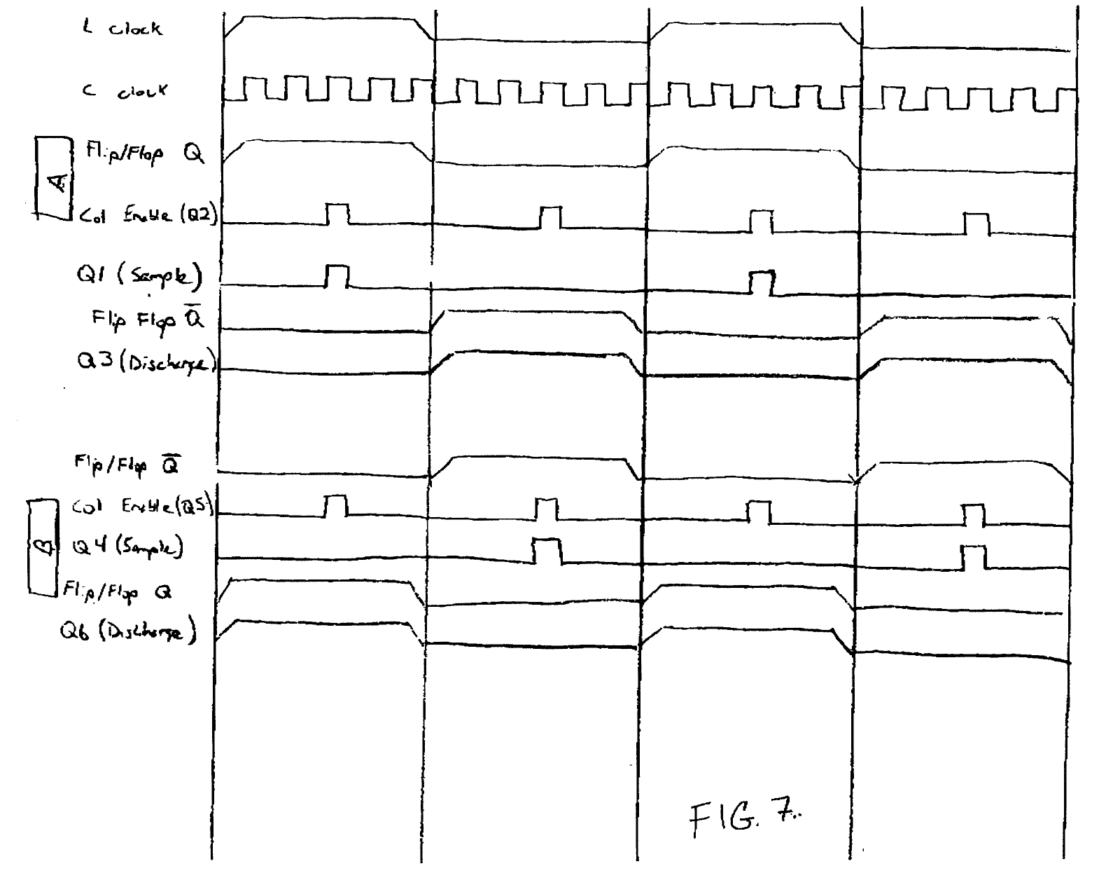

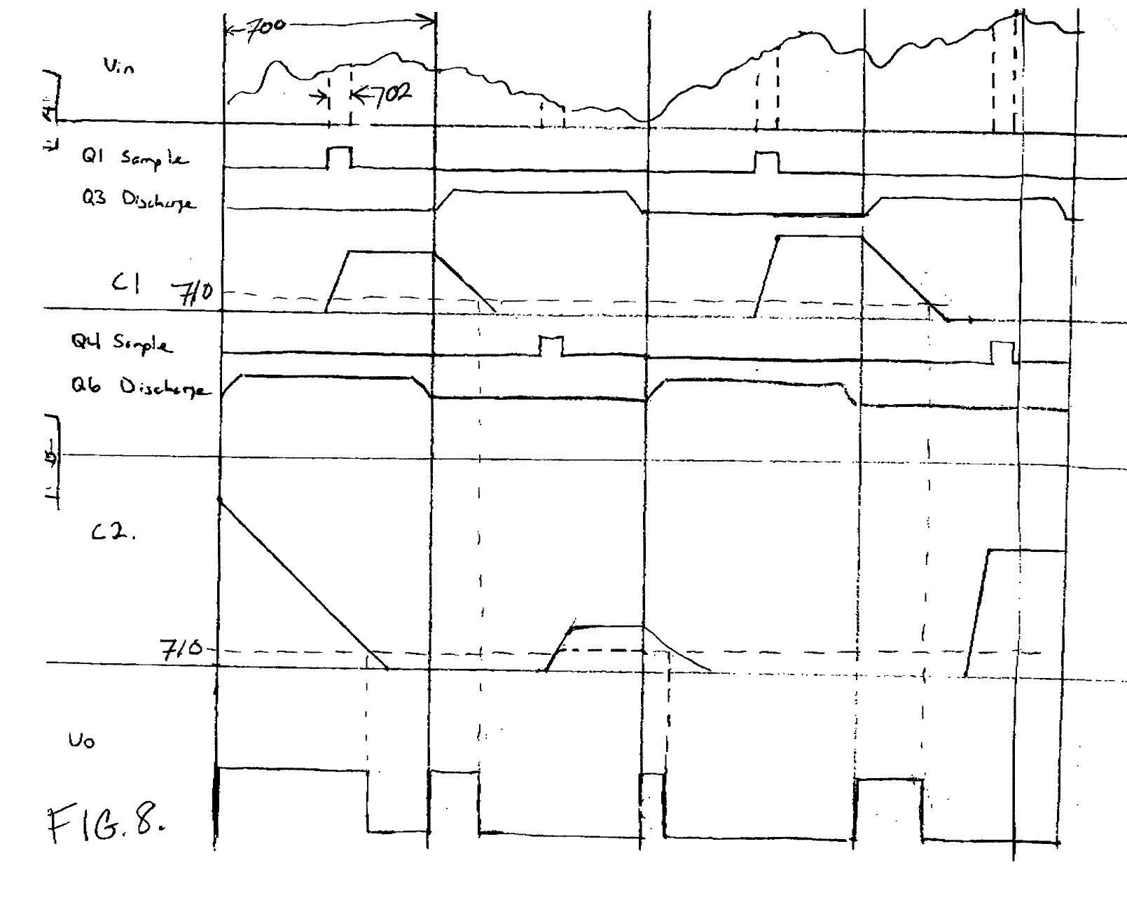

Another embodiment of a suitable circuit for practicing the invention is shown in FIG. 6. In this embodiment, the resistor R2 452 is replaced with constant current sources 516. FIG. 7 illustrates a timing diagram of the sequencers' clocks and the transistors' enabling signals for the A and B states of the circuit shown in FIGS. 4 and 5. FIGS. 7 and 8 illustrate timing diagram of an example sampling and PWM signal generation. In a display line time 700, Q1 310 is enabled for a sample period 702 of the analog video signal. Since Q3 342 is disabled, C1 310 stores the voltage value of the analog video signal within the sample period 702. Still within the display line time 700, Q4 410 is disabled and Q6 is enabled, thereby allowing any voltage stored at C2 424 to discharge through resistor 352 and resistor 452 which are connected to input 354 of the Schmidt trigger S1 356. The Schmidt trigger S1 346 produces a PWM signal by comparing the discharging voltage value from C2 424 to a bias voltage value 710. When the discharging voltage value is at or above the bias voltage value 710, the PWM signal generated is HIGH, otherwise the PWM signal generated is LOW.

Given resistor R2 352 and resistor R4 452 are connected on one end to input 354 and on the other end to ground, it can be appreciated that the circuit can be implemented with only one resistor.

In the case where a comparator is used the discharging voltage value is compared to a received bias voltage value.

While the preferred embodiment of the invention has been illustrated and described, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

I claim:

1. A circuit for generating pulse width modulated signal from an analog video signal, said circuit comprising:
a first circuit portion comprising:
a first switch;
a voltage storage device for storing a portion of the analog video signal as a voltage value according to the first switch activated according to sample time information within a portion of time of the analog video signal; and
a second switch for outputting the stored voltage value when activated according to a next portion of time of the analog video signal; and
a second circuit portion for converting the outputted voltage value into a pulse width modulated signal.

2. The circuit of claim 1, wherein the second circuit portion is a Schmidt trigger with a preset bias voltage value.

3. The circuit of claim 1, wherein the second circuit portion is a comparator.

4. The circuit of claim 1, wherein the voltage storage device is a capacitor.

5. The circuit of claim 1, wherein the stored portion of the analog video signal represents display element information.

6. A circuit for generating pulse width modulated signal from an analog video signal, said circuit comprising:
a first circuit portion comprising:
a first subcircuit portion comprising:
a first switch;
a voltage storage device for storing a portion of the analog video signal as a voltage value within a period of time according to the first switch activated according to sample time information within the period of time; and
a second switch for outputting the stored voltage value when activated during a subsequent period of time; and
a second subcircuit portion comprising:
a first switch;
a voltage storage device for storing a next portion of the analog video signal as a voltage value within the subsequent period of time according to the first switch activated according to sample time information within the subsequent period of time; and
a second switch for outputting a previously stored voltage value when activated during the period of time; and
a second circuit portion for converting the outputted voltage values from the first and second circuit portions into pulse width modulated signals.

7. The circuit of claim 6, wherein the second circuit portion is a Schmidt trigger with a preset bias voltage value.

8. The circuit of claim 6, wherein the second circuit portion is a comparator.

9. The circuit of claim 6, wherein the voltage storage devices are capacitors.

10. The circuit of claim 6, wherein the stored portions of the analog video signal represent display element information.

11. The circuit of claim 6, wherein the first circuit portion further comprises a sequencer for enabling each pulse width modulated signal to drive a display element in a different row of display elements within a frame display period of time.

12. A method for generating pulse width modulated signal from an analog video signal, said method comprising:
storing a portion of the analog video signal as a voltage value according to a switch activated according to sample time information within a portion of time of the analog video signal;
outputting the stored voltage value according to a switch activated according to a next portion of time of the analog video signal; and
converting the outputted voltage value into a pulse width modulated signal.

13. The method of claim 12, wherein converting is performed by a Schmidt trigger with a preset bias voltage value.

14. The method of claim 12, wherein converting is performed by a comparator.

15. The method of claim 12, wherein storing is performed by a capacitor.

16. The method of claim 12, wherein the stored portion of the analog video signal represents display element information.

17. A method for generating pulse width modulated signal from an analog video signal, said method comprising:
storing a portion of the analog video signal as a voltage value within a first circuit portion within a period of time according to a switch activated according to sample time information within the period of time;
outputting a previously stored voltage value within a second circuit portion according to a switch activated during the period of time;
storing a next portion of the analog video signal as a voltage value within the second circuit portion within a subsequent period of time according to a switch activated according to sample time information within the subsequent period of time;
outputting the stored voltage value, that was stored within the first circuit portion according to a switch activated during the subsequent period of time;
converting the outputted voltage values from the first and second circuit portions into pulse width modulated signals.

18. The method of claim 17, wherein converting is performed by a Schmidt trigger with a preset bias voltage value.

19. The method of claim 17, wherein converting is performed by a comparator.

20. The method of claim 17, wherein storing is performed by a capacitor.

21. The method of claim 17, wherein the stored portion of the analog video signal represents display element information.

22. The circuit of claim 17, further comprising:
enabling each pulse width modulated signal to drive a display element in a different row of display elements within a frame display period of time.
